(19) United States
(12) Patent Application Publication
(10) Pub. No.: US 2020/0265436 A1
(43) Pub. Date: Aug. 20, 2020

(54) METHOD AND SYSTEM FOR PROCESSING TRANSACTIONS

(71) Applicant: Mastercard International Incorporated, Purchase, NY (US)

(72) Inventors: Vikas Chandra, Pune (IN); Balamurali Balasubramanian, Chennai (IN)

(73) Assignee: Mastercard International Incorporated, Purchase, NY (US)

(21) Appl. No.: 16/751,375

(22) Filed: Jan. 24, 2020

(30) Foreign Application Priority Data
Feb. 14, 2019 (SG) 10201901289U

(51) Int. Cl. G06Q 20/40; G06Q 20/34

(52) U.S. Cl. CPC G06Q 20/4016; G06Q 20/4037; G06Q 20/3437; G06Q 20/407

(57) ABSTRACT

A method and a system for processing transactions is provided. A terminal device executes a terminal action analysis on a transaction initiated at the terminal device by way of a transaction card. The terminal device compares a fraud count of the terminal device with a threshold fraud limit. If the fraud count exceeds the threshold fraud limit, the terminal device selects a first action from a set of actions for processing the transaction. When the first action is to authorize the transaction online, the terminal device transmits transaction details of the transaction to an acquirer server. The transaction details are indicative of a result of the terminal action analysis. The acquirer server generates an authorization request including a fraud indicator and updates the fraud indicator from a first value to a second value. The acquirer server communicates the authorization request, including the updated fraud indicator, to an issuer for authorization.

### CROSS REFERENCE TO RELATED APPLICATIONS

This application claims priority to Singaporean Application Serial No. 10201901289U, filed Feb. 14, 2019, which is incorporated herein by reference in its entirety

### FIELD OF THE INVENTION

The present invention relates to the field of electronic transactions, and, more particularly to a method and a system for processing transactions initiated by way of a transaction card.

### BACKGROUND

Technological advancements have led to emergence and evolution of transaction systems that use card technologies for enabling users to perform transactions, such as deposits and withdrawals, credit transfers, purchase payments, and the like. The card technologies facilitate the transactions by way of transaction cards, such as credit and debit cards. The transactions at terminal devices (such as automated teller machines or a point-of-sale devices) of the transaction system, typically, require transaction cards to be used at the terminal devices. The terminal devices read information from the transaction cards to process the transactions.

Typically, a terminal device performs certain checks (such as incorrect pin entered, floor limit exceeded, or expired application) before communicating transaction details of a transaction to an acquirer. In one scenario, the terminal device may be a high-risk terminal device and the transaction, though satisfying all the checks, may be fraudulent. When a user realizes that a fraudulent transaction has been performed from an account of the user, the user may file an arbitration chargeback. Filing arbitration chargeback for the fraudulent transaction is a cumbersome process and may cause inconvenience to the user. Based on the arbitration chargeback, the transaction may be cancelled or reversed. The method of arbitration chargebacks is only applicable on fraudulent transactions that are already processed by financial institutions such as acquirers, issuers, and payment networks. Thus, the arbitration chargebacks not only inconvenience the user but also increase the processing overhead of the financial institutions.

In light of foregoing, there exists a need for a solution that reduces the risk of fraudulent transactions being processed, thereby reducing the processing overhead of financial institutions involved in handling arbitration chargebacks for fraudulent transactions.

### SUMMARY

In an embodiment of the present invention, a method for processing transactions is provided. The method includes receiving, by a server from a terminal device, transaction details of a transaction based on a terminal action analysis executed by the terminal device for the transaction. The transaction details are indicative of a result of the terminal action analysis executed by the terminal device. Based on the transaction details, an authorization request, including a fraud indicator, is generated for the transaction by the server. When a fraud count of the terminal device is greater than a threshold fraud limit, the fraud indicator is updated from a first value to a second value by the server. The authorization request, including the updated fraud indicator, is communicated by the server to an issuer for authorizing the transaction.

In another embodiment of the present invention, a system for processing transactions is provided. The system includes an acquirer server that receives transaction details of a transaction from a terminal device, based on a terminal action analysis executed by the terminal device for the transaction. The transaction details are indicative of a result of the terminal action analysis executed by the terminal device. Based on the transaction details, the server generates an authorization request, including a fraud indicator, for the transaction. When a fraud count of the terminal device is greater than a threshold fraud limit, the server updates the fraud indicator from a first value to a second value. The server communicates the authorization request, including the updated fraud indicator, to an issuer for authorizing the transaction.

In another embodiment of the present invention, a method for processing transactions is provided. The method includes executing, by a terminal device, a terminal action analysis for a transaction initiated by way of a transaction card at the terminal device. During the terminal action analysis, a fraud count of the terminal device is compared with a threshold fraud limit by the terminal device. Based on the comparison between the fraud count and the threshold fraud limit, it is determined by the terminal device whether the transaction satisfies a fraud exceeded condition. The fraud exceeded condition is satisfied when the fraud count is greater than the threshold fraud limit. When the fraud exceeded condition is satisfied, a first action is selected by the terminal device for processing the transaction. The first action is selected from a set of actions defined by a set of terminal action codes stored in a first memory of the terminal device and a set of issuer action codes stored in a second memory of the transaction card.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present invention are illustrated by way of example, and not limited by the appended figures, in which like references indicate similar elements:

FIG. 1 is a block diagram that illustrates an exemplary environment for processing transactions, in accordance with an embodiment of the present invention;

FIG. 2 is a table that illustrates exemplary terminal action codes (TAC) and issuer action codes (IAC), in accordance with an embodiment of the present invention;

FIG. 3 is a process flow diagram that illustrates an exemplary scenario for processing transactions performed at a terminal device of FIG. 1, in accordance with an embodiment of the present invention;

FIG. 4 is a process flow diagram that illustrates another exemplary scenario for processing transactions performed at the terminal device of FIG. 1, in accordance with another embodiment of the present invention;

FIG. 5 is a process flow diagram that illustrates another exemplary scenario for processing transactions performed at the terminal device of FIG. 1, in accordance with another embodiment of the present invention;

FIG. 6 is a block diagram that illustrates the terminal device of FIG. 1, in accordance with an embodiment of the present invention;

FIG. 7 is a block diagram that illustrates an acquirer server of FIG. 1, in accordance with an embodiment of the present invention;

FIG. 8 is a block diagram that illustrates a payment network server of FIG. 1, in accordance with an embodiment of the present invention;

FIG. 9 is a block diagram that illustrates an issuer server of FIG. 1, in accordance with an embodiment of the present invention;

FIG. 10 is a block diagram that illustrates a transaction card of FIG. 1, in accordance with an embodiment of the present invention;

FIG. 11 represents a flow chart that illustrates a method for processing transactions initiated at the terminal device of FIG. 1, in accordance with an embodiment of the present invention;

FIG. 12 represents a flow chart that illustrates a method for processing transactions by the acquirer server of FIG. 1, in accordance with an embodiment of the present invention;

FIG. 13 represents a high-level flow chart that illustrates a method for processing transactions initiated at the terminal device of FIG. 1, in accordance with an embodiment of the present invention; and

FIG. 14 is a block diagram that illustrates system architecture of a computer system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### Overview

Generally, a payment network keeps track of all fraudulent transactions that have been performed at a terminal device based on arbitration chargebacks associated with the terminal device. Every time a user initiates a transaction, an issuer has to authorize the transaction. Also, an acquirer of the terminal device, the issuer, and the payment network have to process the transaction again if an arbitration chargeback is filed against the transaction. Thus, the acquirer, the payment network, and the issuer incur a transaction processing overhead.

Various embodiments of the present invention provide a method and a system that solve the abovementioned problem by processing transactions initiated at a terminal device based on a count of fraudulent transactions that have occurred at the terminal device. When a transaction is initiated at the terminal device by way of a transaction card, the terminal device executes a terminal action analysis for the transaction. During the terminal action analysis, the terminal device compares a fraud count of the terminal device with a threshold fraud limit. The fraud count may be stored in a memory of the terminal device and the threshold fraud limit may be stored in a memory of the transaction card. Based on the comparison, the terminal device determines whether a fraud exceeded condition is satisfied for the transaction. The fraud exceeded condition is satisfied when the fraud count is greater than the threshold fraud limit. When the fraud exceeded condition is satisfied, the terminal device selects a first action from a set of actions defined by a set of issuer action codes (IAC) and a set of terminal action codes (TAC) for processing the transaction. The set of IAC is stored in the memory of the transaction card and the set of TAC is stored in the memory of the terminal device. In one embodiment, the first action corresponds to declining the transaction. In such a scenario, the terminal device declines the transaction. In another embodiment, the first action corresponds to online authorization of the transaction. In such a scenario, the terminal device communicates transaction details of the transaction to an acquirer server. The transaction details are indicative of a result of the terminal action analysis executed by the terminal device. The acquirer server generates an authorization request, including a fraud indicator, based on the transaction details and updates the fraud indicator from a first value to a second value, when the fraud count of the terminal device is greater than the threshold fraud limit. The acquirer server communicates the authorization request, including the updated fraud indicator, to an issuer of the transaction card for authorizing the transaction. The transaction is then authorized by the issuer based on the updated fraud indicator.

Since the method and system of the present invention takes into consideration fraudulent transactions performed at the terminal device in past while processing current transactions, a likelihood of a fraudulent transaction getting authorized is reduced. Thus, transaction processing overhead of the acquirer, the issuer and the payment network is reduced.

### Terms Description (in Addition to Plain and Dictionary Meaning)

Account is a payment account that is used for funding transactions. Examples of the account include, but are not limited to, a savings account, a credit account, and/or a checking account. The account is associated with an entity, such as an individual person, a family, a commercial entity, a company, a corporation, a governmental entity, a non-profit organization, or the like. In this scenario, the entity corresponds to an account holder of the account.

Transaction card is a payment means, such as a debit card, a credit card, a prepaid card, a gift card, a promotional card, a contactless card, and/or like, that is linked to an account and holds identification information of the account. The transaction card may be used to perform transactions, such as deposits and cash-withdrawals, credit transfers, purchase payments, or the like, from the account to which it is linked. The transaction card may be a physical card or a virtual card that is electronically stored in a user device. The transaction card may be Europay®, Mastercard®, and Visa® (EMV) chip card enabled for performing transactions.

Terminal device is a computing device affiliated with a financial institution, such as a bank (hereinafter “acquirer”). The terminal device enables users to perform various electronic transactions, such as cash withdrawals, cash deposits, or the like. Examples of the terminal device include, but are not limited to, an Automatic Teller Machine (ATM), a bunch note acceptor (BNA), a currency recycler, a point-of-sale (POS) device, a point-of-purchase (POP), a point-of-interaction (POI), or the like.

Acquirer is a financial institution associated with a terminal device. The acquirer generates an authorization request for a transaction and communicates the authorization request to a payment network.

Issuer is a financial institution where accounts of several users are established and maintained. The issuer ensures payment for authorized transactions in accordance with various payment network regulations and local legislation.

Payment networks, such as those operated by Mastercard, process transactions between acquirers and issuers. Processing by a payment network includes steps of authorization, clearing, and settlement.

A threshold fraud limit is a numerical value set by an issuer for a transaction card. The threshold fraud limit is indicative of a maximum count of fraudulent transactions allowed at a terminal device where the transaction card is used for performing a transaction.

A fraud count is a numerical value that is indicative of a count of fraudulent transactions that have occurred at a terminal device in past. In one example, the fraud count for the terminal device may be determined by an acquirer associated with the terminal device based on a count of arbitration chargebacks associated with the terminal device. In another example, the fraud count for the terminal device may be determined by a payment network based on a count of arbitration chargebacks associated with the terminal device.

A fraud indictor is a data element in an authorization request generated by an acquirer. The fraud indictor indicates that whether a fraud count of a terminal device has exceeded a threshold fraud limit set by an issuer. In one example, the fraud count is a Boolean variable. When the fraud count of the terminal device is less than or equal to the threshold fraud limit, the fraud indictor is set to ‘0’. When the fraud count of the terminal device is greater than the threshold fraud limit, the fraud indictor is updated from ‘0’ to ‘1’.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of a payment network server, an issuer server, or an acquirer server.

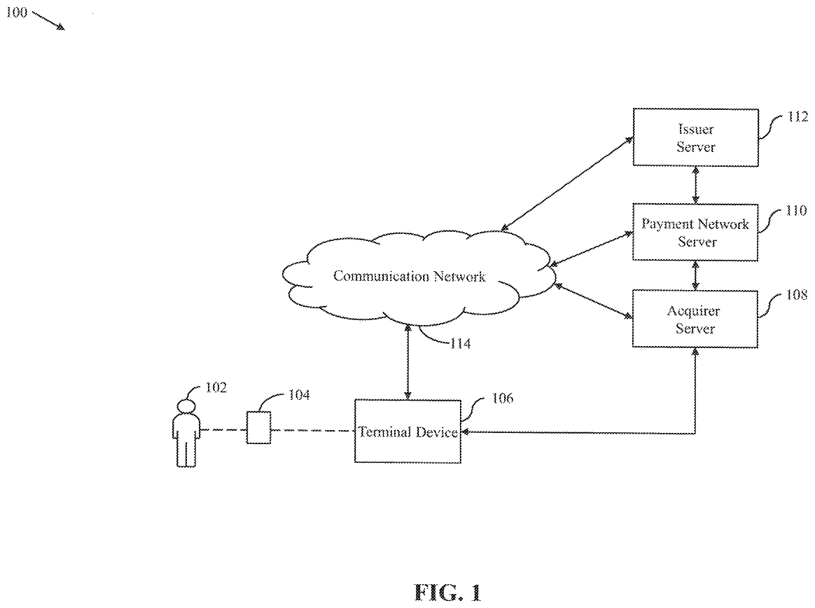

FIG. 1 is a block diagram that illustrates an exemplary environment 100 for processing transactions, in accordance with an embodiment of the present invention. The environment 100 includes a user 102 in possession of a transaction card 104. The environment 100 further includes a terminal device 106, an acquirer server 108, a payment network server 110, and an issuer server 112. The terminal device 106, the acquirer server 108, the payment network server 110, and the issuer server 112 communicate with each other by way of a communication network 114 or through separate communication networks established therebetween.

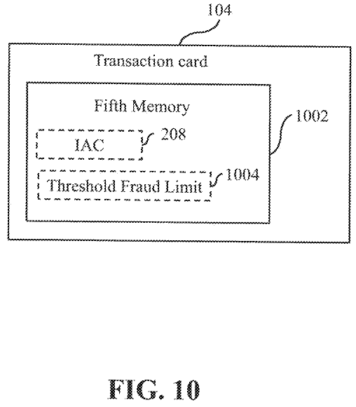

The user 102 is an individual, who is an account holder of a user account maintained by a financial institution, such as an issuer. The issuer may have issued the transaction card 104 to the user 102 for performing transactions from the user account. The transaction card 104 is linked to the user account and stores identification information of the user account (hereinafter, referred to as “account information” of the user account) in the form of an electronic chip. The account information may include an account number, a name of an account holder (i.e., the user 102), or the like. The transaction card 104 has a unique card number, an expiry date, a card security code, and a card type associated with it. The unique card number, the expiry date, the card security code, and the card type are collectively referred to as card details of the transaction card 104. In one embodiment, the transaction card 104 is a physical card used for performing the transactions at the terminal device 106. In another embodiment, the transaction card 104 is a virtual card stored in a memory of a user device (not shown) of the user 102. The transaction card 104 further stores a set of issuer action codes (IAC) (hereinafter, the set of IAC is referred to as “IAC”). The IAC is set by the issuer and defines actions that are to be performed for processing a transaction initiated by way of the transaction card 104. The actions may include declining the transaction offline, authorizing the transaction online, declining the transaction offline when the issuer is unavailable for authorization, or the like. The transaction card 104 further stores a threshold fraud limit set by the issuer (as shown in FIG. 10). Examples of the transaction card 104 include a credit card, a debit card, a membership card, a promotional card, a charge card, a prepaid card, a gift card, or the like. In one embodiment, the transaction card 104 may be an EMV chip card.

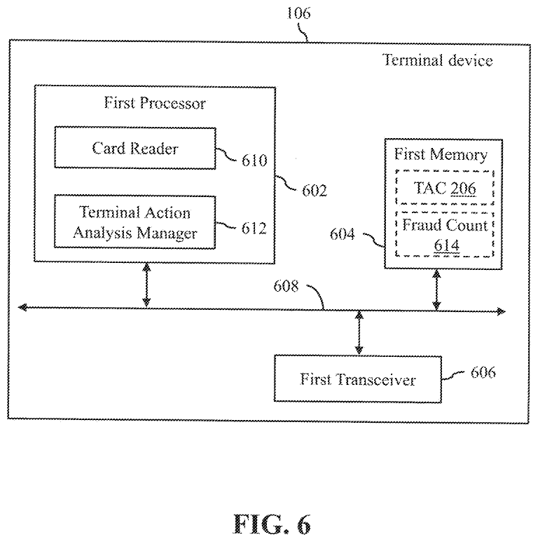

The terminal device 106 includes suitable logic, circuitry, interfaces, and/or codes, executed by the circuitry, to allow users (such as the user 102) to perform transactions (such as cash deposit, cash-withdrawal, and/or balance enquiry) from corresponding user accounts. The terminal device 106 may be associated with a financial institution, such as an acquirer. Examples of the terminal device 106 include an ATM, a BNA, a currency recycler, a POP device, a POI device, a POS, or the like. The terminal device 106 stores a set of terminal action codes (TAC) (hereinafter, the set of TAC is referred to as “TAC”) and a fraud count in a memory associated therewith (as shown in FIG. 6). The TAC is set by the acquirer server 108 and defines actions that are to be performed for processing a transaction initiated at the terminal device 106. The actions may include declining the transaction offline, authorizing the transaction online, declining the transaction offline when the issuer is unavailable for authorization, or the like. The fraud count stored in the memory of the terminal device 106 indicates a count of fraudulent transactions performed at the terminal device 106, in past.

The terminal device 106 reads the card details of the transaction card 104, the IAC, and the threshold fraud limit when the user 102 uses the transaction card 104 at the terminal device 106 for initiating a transaction. The terminal device 106 executes a terminal action analysis for the transaction to determine whether a fraud limit exceeded condition is true. The fraud limit exceeded condition is determined to be true when the fraud count of the terminal device 106 is greater than the threshold fraud limit. When the fraud limit exceeded condition is true, the terminal device 106 selects an action from the actions defined by a combination of the IAC and the TAC for processing the transaction.

In one embodiment, the selected action is to decline the transaction offline. In such a scenario, the terminal device 106 declines the transaction. In another embodiment, the selected action is to authorize the transaction online. In such a scenario, the terminal device 106 communicates transaction details of the transaction to the acquirer server 108. The transaction details are indicative of a result of the terminal action analysis executed by the terminal device 106. The transaction details may include the card details, account information, a transaction amount, a timestamp of the transaction, a transaction identifier (ID) of the transaction, or the like. The transaction details may further include additional information and/or data elements that are pursuant to one or more standards for the interchange of transaction messages, such as the ISO 8583 standard. It will be apparent to a person of ordinary skill in the art that the terminal device 106 may execute the terminal action analysis for various other conditions, such as an expired application condition, a pin limit exceeded condition, an above floor limit condition, or the like.

The acquirer server 108 is a computing server that is operated by the acquirer and includes suitable logic, circuitry, interfaces, and/or codes, executed by the circuitry, for processing the transactions performed at the terminal device 106. In one embodiment, the acquirer server 108 may determine the fraud count of the terminal device 106 based on the arbitration chargebacks associated with the terminal device 106. The acquirer server 108 may store the TAC and the fraud count of the terminal device 106 in the memory of the terminal device 106. The acquirer server 108 receives the transaction details of the transaction from the terminal device 106 when the action selected by the terminal device 106 is to authorize the transaction online. Based on the transaction details, the acquirer server 108 generates an authorization request including a fraud indicator. In one example, the authorization request is a message pursuant to one or more standards for the interchange of transaction messages, such as the ISO 8583 standard. In such a scenario, the fraud indicator is included in a tag 95 of a data element 55 of the authorization request. The acquirer server 108 updates the fraud indicator from a first value to a second value when the transaction details indicate that the fraud count of the terminal device 106 is greater than the threshold fraud limit. For example, the acquirer server 108 updates the fraud indicator from ‘0’ to ‘1’, when the fraud count of the terminal device 106 is greater than the threshold fraud limit. The acquirer server 108 communicates the authorization request, including the updated fraud counter, to the payment network server 110. In one embodiment, the acquirer server 108 may update the TAC and the fraud count stored in the memory of the terminal device 106.

The payment network server 110 is a computing server that is operated by a payment network and includes suitable logic, circuitry, interfaces, and/or codes, executed by the circuitry, for processing transactions. The payment network server 110 represents an intermediate entity between the acquirer server 108 and the issuer server 112 for authorizing and funding the transactions performed by way of transaction cards, for example the transaction card 104. The payment network server 110 communicates the authorization request, including the updated fraud counter, to the issuer server 112. Examples of various payment networks include Mastercard, Discover®, Diners Club®, or the like. In one embodiment, the payment network server 110 may maintain a record of fraudulent transactions performed at various terminal devices, such as the terminal device 106. The payment network server 110 may communicate the record of fraudulent transactions performed at the terminal device 106 to the acquirer server 108. In one embodiment, the payment network server 110 may determine the fraud count of the terminal device 106 based on the record of fraudulent transactions and the count of arbitration chargebacks associated with the terminal device 106.

The issuer server 112 is a computing server that is operated by the issuer and includes suitable logic, circuitry, interfaces, and/or codes, executed by the circuitry, for processing transactions. The issuer is a financial institution that manages user accounts of multiple users. Account details of the user accounts, such as the user account of the user 102, established with the issuer are stored as account profiles in a memory (not shown) of the issuer server 112 or on a cloud server associated with the issuer server 112. The account details may include an account balance, an available credit line, details of an account holder, transaction history of the account holder, account information, or the like. The details of the account holder may include name, age, gender, physical attributes, registered contact number, alternate contact number, registered e-mail ID, or the like of the account holder. The issuer server 112 stores the IAC in the memory of the transaction card 104. The issuer server 112 receives the authorization request, including the updated fraud indicator, from the payment network server 110. The issuer server 112 authorizes the transaction based on the updated fraud indicator. Methods for processing transactions via the issuer server 112 will be apparent to a person of ordinary skill in the art and may include processing the transaction via the traditional four-party system or the traditional three-party system.

Examples of the acquirer server 108, the payment network server 110, and the issuer server 112, include, but are not limited to, computers, laptops, mini-computers, mainframe computers, any non-transient and tangible machines that can execute a machine-readable code, cloud-based servers, distributed server networks, a network of computer systems, or a combination thereof.

The communication network 114 is a medium through which content and messages are transmitted between the terminal device 106, the acquirer server 108, the payment network server 110, the issuer server 112, or other entities that are pursuant to one or more standards for the interchange of transaction messages, such as the ISO8583 standard. Examples of the communication network 114 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 114 in accordance with various wired and wireless communication protocols, such as Transmission Control Protocol and Internet Protocol (TCP/IP), User Datagram Protocol (UDP), Long Term Evolution (LTE) communication protocols, or any combination thereof.

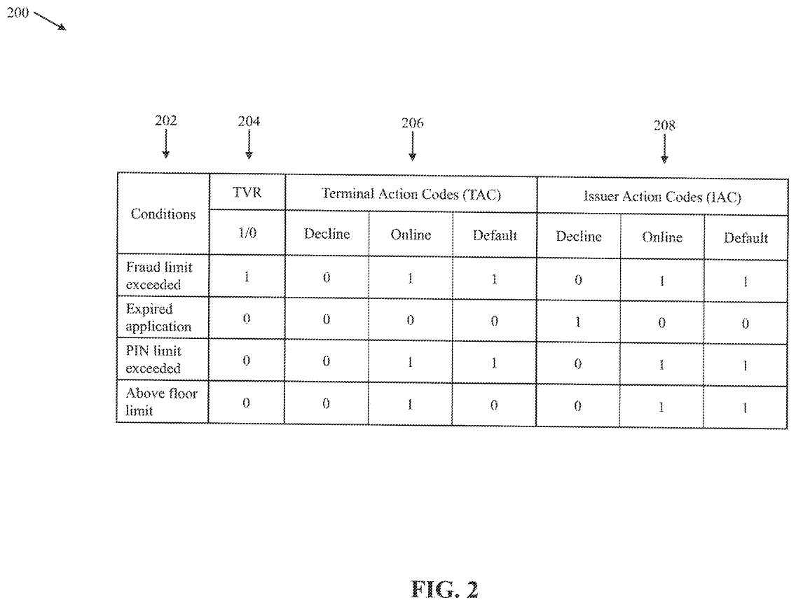

FIG. 2 is a table 200 that illustrates the TAC and the IAC, in accordance with an embodiment of the present invention. Table 200 includes a conditions column 202, a terminal verification result (TVR) column 204, TAC 206, and IAC 208.

The user 102 may use the transaction card 104 to initiate a transaction at the terminal device 106. The terminal device 106 reads the card details of the transaction card 104, the IAC 208, the threshold fraud limit, and one or more other parameters stored by the transaction card 104. The terminal device 106 then executes the terminal action analysis for the transaction. During the terminal action analysis, the terminal device 106 determines whether conditions specified in the conditions column 202 are true for the transaction. Examples of the conditions may include, but are not limited to the fraud limit exceeded condition, an expired application condition, a pin limit exceeded condition, and/or an above floor limit condition.

The TVR column 204 indicates whether a corresponding condition specified in the conditions column 202 is true or false. For example, when the fraud limit exceeded condition is determined to be true for the transaction, the terminal device 106 stores a value ‘1’ in the TVR column 204 for the fraud limit exceeded condition. In another example, when the fraud limit exceeded condition is determined to be false for the transaction, the terminal device 106 stores a value ‘0’ in the TVR column 204 for the fraud limit exceeded condition. In a non-limiting example, it is assumed that the fraud limit exceeded condition is true for the transaction and other conditions specified in the conditions column 202 are false. Thus, the TVR column 204 has a value ‘1’ for the fraud limit exceeded condition and values ‘0’ for other conditions, for example, the expired application condition, the pin limit exceeded condition, and/or the above floor limit condition. When the value of the TVR column 204 is equal to ‘1’ for a condition specified in the conditions column 202, the terminal device 106 selects an action defined by the combination of the TAC 206 and the IAC 208.

The TAC 206 and the IAC 208 define various actions to be performed for processing the transaction. The actions include declining the transaction offline (i.e., “decline” action in the TAC 206 and the IAC 208), authorizing the transaction online (i.e., “online” action in the TAC 206 and the IAC 208), and declining the transaction offline when the issuer corresponding to the transaction is unavailable (i.e., “default” action in the TAC 206 and the IAC 208). Each action defined by the TAC 206 and the IAC 208 may have a value, for example, ‘0’ or ‘1’, corresponding to the conditions specified in the conditions column 202. For a condition specified in the conditions column 202, an action having the value ‘1’ corresponds to a valid action and an action having the value ‘0’ corresponds to an invalid action.

In an exemplary scenario, when the value in the TVR column 204 is ‘1’ for the fraud limit exceeded condition, the terminal device 106 reads the values of the decline, online, and default actions in the TAC 206 and the IAC 208 corresponding to the fraud limit exceeded condition. In Table 200, the decline, online, and default actions in the TAC 206 are shown to have values ‘0’, ‘1’, and ‘1’, respectively, for the fraud limit exceeded condition. Similarly, the decline, online, and default actions in the IAC 208 are shown to have values ‘0’, ‘1’, and ‘1’, respectively, for the fraud limit exceeded condition. The terminal device 106 selects the action for which the value is ‘1’, for example, the online action or the default action and processes the transaction based on the selected action. In one embodiment, the terminal device 106 may perform various logical operations (for example, logical OR operation) on the actions defined by the TAC 206 and the IAC 208 for selecting the action.

In one embodiment, when two actions have the value ‘1’, the terminal device 106 may select an action that has a lower risk score. The risk score may be defined by the acquirer server 108. For example, the online action may have the lowest risk score. In one embodiment, when two actions have the value ‘1’, the terminal device 106 may select an action that has a higher preference score. The preference score may be defined by the acquirer server 108. For example, the online action may have a higher preference score than the default action. In another embodiment, if there is a conflict among the actions defined by the TAC 206 and the IAC 208, the terminal device 106 may select an action that has a lower risk score. For example, the decline, online, and default actions in the TAC 206 may have values ‘1’, ‘0’, and ‘0’, respectively, for the fraud limit exceeded condition, and the decline, online, and default actions in the IAC 208 may have values ‘0’, ‘1’, and ‘1’, respectively, for the fraud limit exceeded condition. In such a scenario, the terminal device 106 may select the online action based on the IAC 208 when the risk score of the online action is lower than the decline action. In another scenario, the terminal device 106 may select the decline action based on the TAC 206 when the risk score of the decline action is lower than the online action.

It will be apparent to a person of ordinary skill in the art that Table 200 is shown for illustrative purpose and should not be construed to limit the scope of the disclosure. In another embodiment, the TAC 206 and the IAC 208 may have values that are different from the values illustrated in Table 200 and the conditions column 202 may include other conditions that are known to those of skill in the art.

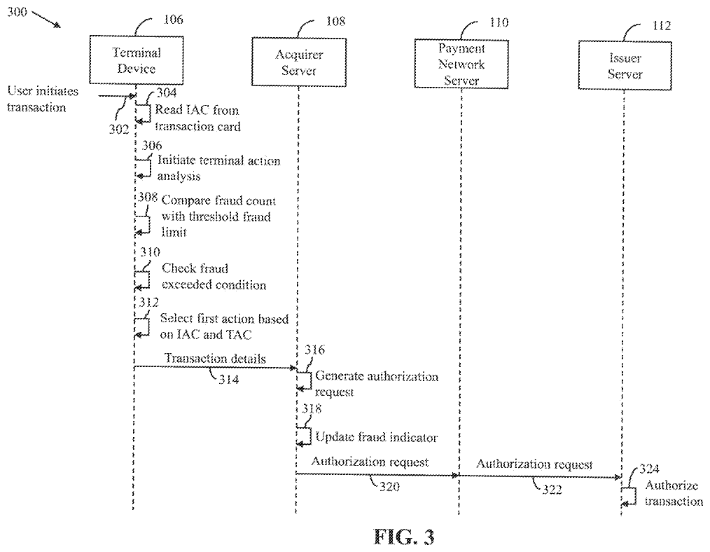

FIG. 3 is a process flow diagram 300 that illustrates an exemplary scenario for processing transactions performed at the terminal device 106, in accordance with an embodiment of the present invention. The process flow diagram 300 involves the terminal device 106, the acquirer server 108, the payment network server 110, and the issuer server 112.

A transaction is initiated by the user 102 at the terminal device 106 (as shown by arrow 302). The user 102 may initiate the transaction by using the transaction card 104. The terminal device 106 reads the card details, the IAC 208, and the threshold fraud limit stored in the memory of the transaction card 104 (as shown by arrow 304). After reading the card details, the IAC 208, and the threshold fraud limit from the transaction card 104, the terminal device 106 initiates the terminal action analysis for the transaction (as shown by arrow 306).

During the terminal action analysis, the terminal device 106 compares the fraud count stored in the memory of the terminal device 106 with the threshold fraud limit read from the transaction card 104 (as shown by arrow 308). The terminal device 106 then determines (i.e., checks) whether the fraud exceeded condition is satisfied for the transaction (as shown by arrow 310). The fraud exceeded condition is determined to be satisfied when the fraud count is greater than the threshold fraud limit. It will be apparent to those of skill in the art that the terminal device 106 further determines whether other conditions specified in the conditions column 202 are satisfied. In a non-limiting example, it is assumed that the fraud exceeded condition is satisfied. The terminal device 106 then updates the TVR column 204 with the value ‘1’ for the fraud exceeded condition. The terminal device 106 selects a first action from the actions defined by the TAC 206 and the IAC 208 for processing the transaction (as shown by arrow 312). The actions defined by the TAC 206 and the IAC 208 are described in the foregoing description of FIG. 2. For the sake of ongoing description of FIG. 3, it is assumed that the first action selected by the terminal device 106 is to authorize the transaction online.

Based on the first action (i.e., the online action) that is selected, the terminal device 106 communicates transaction details of the transaction to the acquirer server 108 (as shown by arrow 314). The transaction details are indicative of the result of the terminal action analysis executed by the terminal device 106. For example, the transaction details may include details of the TVR column 204 to indicate the result of the terminal action analysis. The transaction details may further include additional information and/or data elements that are pursuant to the ISO 8583 standard. The acquirer server 108 receives the transaction details of the transaction from the terminal device 106. Based on the transaction details, the acquirer server 108 generates an authorization request for the transaction (as shown by arrow 316). The authorization request includes the fraud indicator. In one example, the authorization request is pursuant to the ISO 8583 standard and the fraud indicator is a tag 95 of the data element 55 included in the authorization request. The acquirer server 108 updates the fraud indicator in the authorization request from ‘0’ to ‘1’ as the fraud count of the terminal device 106 has exceeded the threshold fraud limit set by the issuer server 112 (as shown by arrow 318). The acquirer server 108 communicates the authorization request, including the updated fraud indicator, to the payment network server 110 (as shown by arrow 320). The payment network server 110 communicates the authorization request, including the updated fraud indicator, to the issuer server 112 (as shown by arrow 322). The issuer server 112 may authorize the transaction based on the authorization request including the updated fraud indicator (as shown by arrow 324) and generate an authorization response. The authorization response indicates the result of authorization and is transmitted by the issuer server 112 to the terminal device 106 through the payment network server 110 and the acquirer server 108.

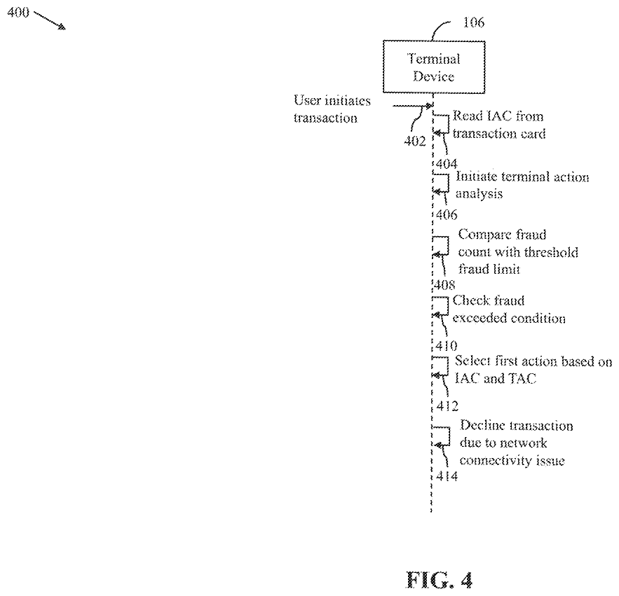

FIG. 4 is a process flow diagram 400 that illustrates an exemplary scenario for processing transactions performed at the terminal device 106, in accordance with an embodiment of the present invention. The process flow diagram 400 involves the terminal device 106.

A transaction is initiated by the user 102 at the terminal device 106 (as shown by arrow 402). The user 102 may initiate the transaction by using the transaction card 104. The terminal device 106 reads the card details, the IAC 208 and the threshold fraud limit stored in the memory of the transaction card 104 (as shown by arrow 404). After reading the card details, the IAC 208, and the threshold fraud limit from the transaction card 104, the terminal device 106 initiates the terminal action analysis for the transaction (as shown by arrow 406).

During the terminal action analysis, the terminal device 106 compares the fraud count stored in the memory of the terminal device 106 with the threshold fraud limit read from the transaction card 104 (as shown by arrow 408). The terminal device 106 then determines (i.e., checks) whether the fraud exceeded condition is satisfied (as shown by arrow 410). The fraud exceeded condition is determined to be satisfied when the fraud count is greater than the threshold fraud limit. It will be apparent to those of skill in the art that the terminal device 106 further determines whether other conditions specified in the conditions column 202 are satisfied. In a non-limiting example, it is assumed that the fraud exceeded condition is satisfied. The terminal device 106 then updates the TVR column 204 with the value ‘1’ for the fraud exceeded condition. The terminal device 106 selects a first action from the actions defined by the TAC 206 and the IAC 208 for processing the transaction (as shown by arrow 412). The actions defined by the TAC 206 and the IAC 208 are described in the foregoing description of FIG. 2. For the sake of ongoing description of FIG. 4, it is assumed that the first action selected by the terminal device 106 is the default action. The terminal device 106 may select the default action due to unavailability of the issuer server 112 or lack of network connectivity. Thus, based on the selection of the default action, the terminal device 106 declines the transaction offline (as shown by arrow 414).

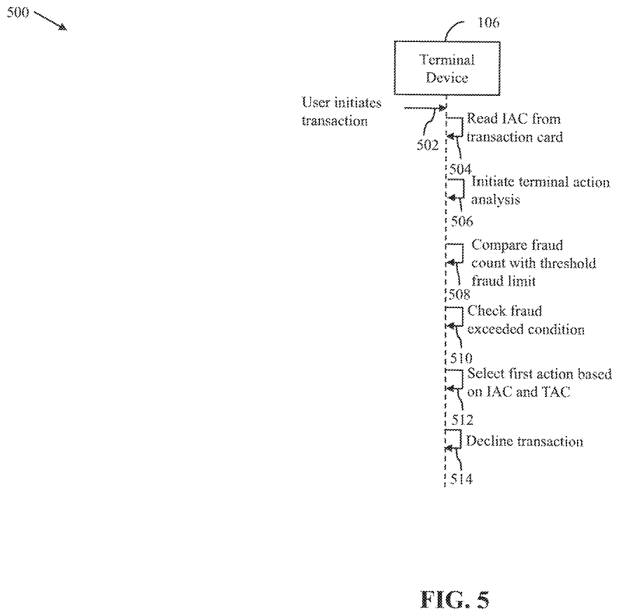

FIG. 5 is a process flow diagram 500 that illustrates an exemplary scenario for processing transactions performed at the terminal device 106, in accordance with an embodiment of the present invention. The process flow diagram 500 involves the terminal device 106.

A transaction is initiated by the user 102 at the terminal device 106 (as shown by arrow 502). The user 102 may initiate the transaction by using the transaction card 104. The terminal device 106 reads the card details, the IAC 208, and the threshold fraud limit stored in the memory of the transaction card 104 (as shown by arrow 504). After reading the card details, the IAC 208, and the threshold fraud limit from the transaction card 104, the terminal device 106 initiates the terminal action analysis for the transaction (as shown by arrow 506).

During the terminal action analysis, the terminal device 106 compares the fraud count stored in the memory of the terminal device 106 with the threshold fraud limit read from the transaction card 104 (as shown by arrow 508). The terminal device 106 then determines (i.e., checks) whether the fraud exceeded condition is satisfied (as shown by arrow 510). The fraud exceeded condition is determined to be satisfied when the fraud count is greater than the threshold fraud limit. In a non-limiting example, it is assumed that the fraud exceeded condition is satisfied. The terminal device 106 then updates the TVR column 204 with the value ‘1’ for the fraud exceeded condition. The terminal device 106 selects a first action from the actions defined by the TAC 206 and the IAC 208 for processing the transaction (as shown by arrow 512). The actions defined by the TAC 206 and the IAC 208 are described in the foregoing description of FIG. 2. In a non-limiting example, it is assumed that the first action selected by the terminal device 106 is the decline action. Thus, based on the selection of the decline action, the terminal device 106 declines the transaction offline (as shown by arrow 514).

FIG. 6 is a block diagram that illustrates the terminal device 106, in accordance with an embodiment of the present invention. The terminal device 106 includes a first processor 602, a first memory 604, and a first transceiver 606. The first processor 602, the first memory 604, and the first transceiver 606 communicate with each other by way of a first communication bus 608.

The first processor 602 includes suitable logic, circuitry, interfaces and/or codes, executable by the circuitry, for processing transactions performed at the terminal device 106. The first processor 602 executes the terminal action analysis for the transaction initiated at the terminal device 106. The first processor 602 communicates the transaction details of the transaction to the acquirer server 108 when the online action is selected during the terminal action analysis (as described in FIG. 3). Examples of the first processor 602 may include, but are not limited to, an application specific integrated circuit (ASIC) processor, a reduced instruction set computer (RISC) processor, a complex instruction set computer (CISC) processor, a field programmable gate array (FPGA), or the like. The first processor 602 includes a card reader 610 and a terminal action analysis manager 612.

When the user 102 initiates the transaction by way of the transaction card 104, the card reader 610 reads the information stored in the memory of the transaction card 104. The information may include the card details, the IAC 208, the threshold fraud limit, or the like. The terminal action analysis manager 612 executes the terminal action analysis for the transaction initiated at the terminal device 106 as described in FIGS. 3, 4, and 5. The terminal action analysis manager 612 compares the fraud count of the terminal device 106 with the threshold fraud limit read from the memory of the transaction card 104. The terminal action analysis manager 612 then determines whether the fraud exceeded condition and other conditions specified in the conditions column 202 are satisfied. If the fraud exceeded condition and/or any other condition is satisfied, the terminal action analysis manager 612 selects an action from the actions defined by the TAC 206 and the IAC 208.

The first memory 604 includes suitable logic, circuitry, interfaces and/or codes, executable by the circuitry, for storing the TAC 206. The first memory 604 may further store a fraud count 614 of the terminal device 106. Examples of the first memory 604 may include, but are not limited to, a random-access memory (RAM), a read-only memory (ROM), a removable storage drive, a hard-disk drive (HDD), a flash memory, a solid-state memory, or the like. It will be apparent to a person skilled in the art that the scope of the invention is not limited to realizing the first memory 604 in the terminal device 106, as described herein. In another embodiment, the first memory 604 may be realized in form of a database server or a cloud storage working in conjunction with the terminal device 106, without departing from the scope of the invention.

The first transceiver 606 includes suitable logic, circuitry, interfaces and/or codes, executable by the circuitry, for transmitting and receiving data over the communication network 114 using one or more communication protocols. The first transceiver 606 may transmit various requests and messages to the acquirer server 108. For example, the first transceiver 606 may transmit the transaction details of the transaction to the acquirer server 108. The first transceiver 606 may further receive various requests and messages from the acquirer server 108. For example, the first transceiver 606 may receive the authorization response generated by the issuer server 112. Examples of the first transceiver 606 may include, but are not limited to, an antenna, a radio frequency transceiver, a wireless transceiver, a Bluetooth transceiver, an Ethernet port, a universal serial bus (USB) port, or any other device configured to transmit and receive data.

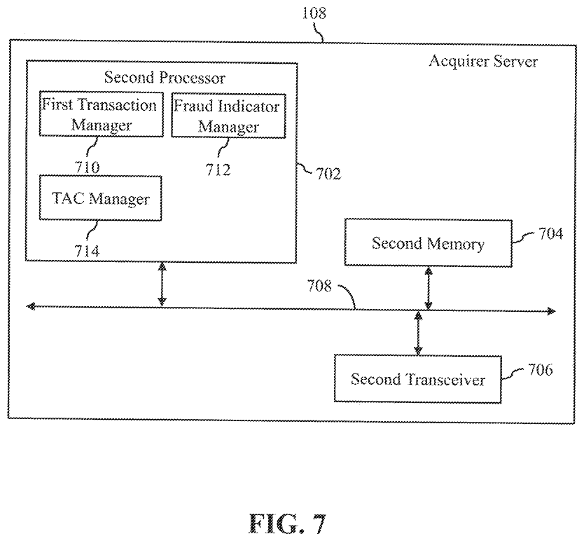

FIG. 7 is a block diagram that illustrates the acquirer server 108, in accordance with an embodiment of the present invention. The acquirer server 108 includes a second processor 702, a second memory 704, and a second transceiver 706. The second processor 702, the second memory 704, and the second transceiver 706 communicate with each other by way of a second communication bus 708.

The second processor 702 includes suitable logic, circuitry, interfaces and/or codes, executable by the circuitry, for processing transactions performed at the terminal device 106. The second processor 702 generates the authorization request based on the transaction details of the transaction received from the terminal device 106. The second processor 702 communicates the authorization request including the updated fraud indicator to the payment network server 110. Examples of the second processor 702 may include, but are not limited to, an ASIC processor, a RISC processor, a CISC processor, an FPGA, or the like. The second processor 702 includes a first transaction manager 710, a fraud indicator manager 712, and a TAC manager 714.

The first transaction manager 710 processes the transaction that corresponds to the acquirer server 108. The first transaction manager 710 generates the authorization request, including the fraud indicator, for the transaction based on the transaction details received from the terminal device 106. The fraud indicator manager 712 updates the fraud indicator, included in the authorization request, when the fraud count 614 of the terminal device 106 is greater than the threshold fraud limit. The fraud indicator manager 712 further determines a value of the fraud count 614 based on the arbitration chargebacks associated with the terminal device 106 and stores the fraud count 614 in the first memory 604. The fraud indicator manager 712 may update the stored fraud count 614 based on the information pertaining to fraudulent transactions received from the payment network server 110. The TAC manager 714 manages and stores the TAC 206 in the first memory 604. The TAC manager 714 may update the TAC 206 as per system requirements.

The second memory 704 includes suitable logic, circuitry, interfaces and/or codes, executable by the circuitry, for storing fraud counts of various terminal devices, for example, the fraud count 614 of the terminal device 106. The second memory 704 further stores the transaction details associated with various transactions that are associated with the acquirer server 108. Examples of the second memory 704 may include a RAM, a ROM, a removable storage drive, an HDD, a flash memory, a solid-state memory, or the like. It will be apparent to a person skilled in the art that the scope of the invention is not limited to realizing the second memory 704 in the acquirer server 108, as described herein. In another embodiment, the second memory 704 may be realized in form of a database server or a cloud storage working in conjunction with the acquirer server 108, without departing from the scope of the invention.

The second transceiver 706 includes suitable logic, circuitry, interfaces and/or codes, executable by the circuitry, for transmitting and receiving data over the communication network 114 using one or more communication protocols. The second transceiver 706 may transmit various requests and messages to the payment network server 110. For example, the second transceiver 706 may transmit the authorization request including the updated fraud indicator to the payment network server 110. The second transceiver 706 may further receive various requests and messages from the payment network server 110. For example, the second transceiver 706 may receive the authorization response from the payment network server 110. Examples of the second transceiver 706 include, but are not limited to, an antenna, a radio frequency transceiver, a wireless transceiver, a Bluetooth transceiver, an Ethernet port, a USB port, or any other device configured to transmit and receive data.

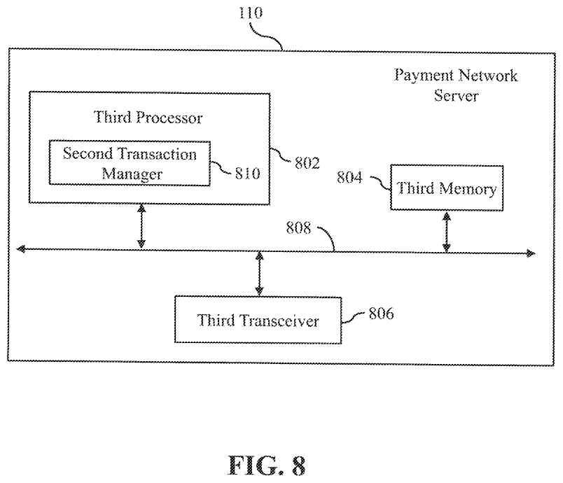

FIG. 8 is a block diagram that illustrates the payment network server 110, in accordance with an embodiment of the present invention. The payment network server 110 includes a third processor 802, a third memory 804, and a third transceiver 806. The third processor 802, the third memory 804, and the third transceiver 806 communicate with each other by way of a third communication bus 808.

The third processor 802 includes suitable logic, circuitry, interfaces and/or codes, executable by the circuitry, for processing transactions performed by way of transaction cards, such as the transaction card 104. Examples of the third processor 802 may include, but are not limited to, an ASIC processor, a RISC processor, a CISC processor, an FPGA, or the like. The third processor 802 includes a second transaction manager 810. The second transaction manager 810 identifies an issuer that corresponds to the transaction based on the authorization request received from the acquirer server 108.

The third memory 804 includes suitable logic, circuitry, interfaces and/or codes, executable by the circuitry, for maintaining the record of fraudulent transactions performed at various terminal devices, such as the terminal device 106. The third memory 804 further stores transaction history of the transactions performed by way of the transaction card 104. Examples of the third memory 804 may include a RAM, a ROM, a removable storage drive, an HDD, a flash memory, a solid-state memory, or the like. It will be apparent to a person skilled in the art that the scope of the invention is not limited to realizing the third memory 804 in the payment network server 110, as described herein. In another embodiment, the third memory 804 may be realized in form of a database server or a cloud storage working in conjunction with the payment network server 110, without departing from the scope of the invention.

The third transceiver 806 includes suitable logic, circuitry, interfaces and/or codes, executable by the circuitry, for transmitting and receiving data over the communication network 114 using one or more communication protocols. The third transceiver 806 may transmit various requests and messages to the issuer server 112. For example, the third transceiver 806 may transmit the authorization request, including the updated fraud indicator, to the issuer server 112. The third transceiver 806 may further receive various requests and messages from the issuer server 112. For example, the third transceiver 806 may receive the authorization response generated by the issuer server 112. Examples of the third transceiver 806 may include, but are not limited to, an antenna, a radio frequency transceiver, a wireless transceiver, a Bluetooth transceiver, an Ethernet port, a USB port, or any other device configured to transmit and receive data.

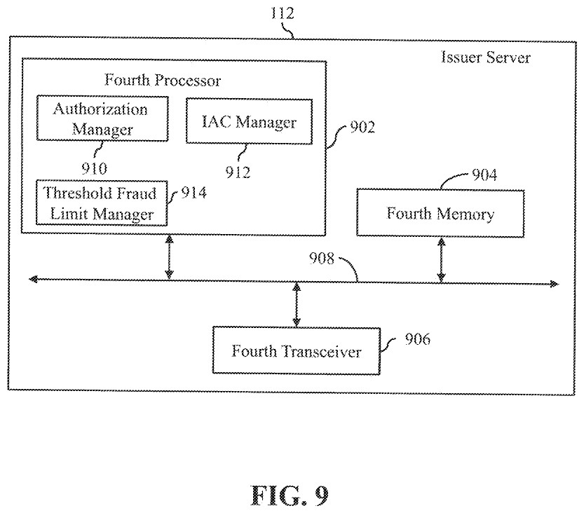

FIG. 9 is a block diagram that illustrates the issuer server 112, in accordance with an embodiment of the present invention. The issuer server 112 includes a fourth processor 902, a fourth memory 904, and a fourth transceiver 906. The fourth processor 902, the fourth memory 904, and the fourth transceiver 906 communicate with each other by way of a fourth communication bus 908.

The fourth processor 902 includes suitable logic, circuitry, interfaces and/or codes, executable by the circuitry, for processing transactions performed by way of the transaction card 104. Examples of the fourth processor 902 may include, but are not limited to, an ASIC processor, a RISC processor, a CISC processor, an FPGA, or the like. The fourth processor 902 includes an authorization manager 910, an IAC manager 912, and a threshold fraud limit manager 914. The authorization manager 910 authorizes the transaction that are associated with the issuer server 112 and authenticates users (e.g., the user 102) who perform the transactions. Based on the authorization of the transactions, the authorization manager 910 generates authorization responses. The IAC manager 912 manages the IAC 208 stored in the memory of the transaction card 104. The IAC manager 912 may update the IAC 208. For example, when the transaction card 104 is used at the terminal device 106, the IAC manager 912 may communicate instructions to the terminal device 106, by way of the payment network server 110 and the acquirer server 108, for updating the IAC 208. The threshold fraud limit manager 914 determines the threshold fraud limit and stores the value of the threshold fraud limit in the memory of the transaction card 104. The threshold fraud limit manager 914 may update the threshold fraud limit over a period of time. For example, when the transaction card 104 is used at the terminal device 106, the threshold fraud limit manager 914 may communicate instructions to the terminal device 106, by way of the payment network server 110 and the acquirer server 108, for updating the threshold fraud limit.

The fourth memory 904 includes suitable logic, circuitry, interfaces and/or codes, executable by the circuitry, for storing transaction details of the transactions associated with the issuer server 112. Examples of the fourth memory 904 may include a RAM, a ROM, a removable storage drive, an HDD, a flash memory, a solid-state memory, or the like. It will be apparent to a person skilled in the art that the scope of the invention is not limited to realizing the fourth memory 904 in the issuer server 112, as described herein. In another embodiment, the fourth memory 904 may be realized in form of a database server or a cloud storage working in conjunction with the issuer server 112, without departing from the scope of the invention.

The fourth transceiver 906 includes suitable logic, circuitry, interfaces and/or codes, executable by the circuitry, for transmitting and receiving data over the communication network 114 using one or more communication protocols. The fourth transceiver 906 may receive various requests and messages from the payment network server 110. For example, the fourth transceiver 906 may receive the authorization request, including the updated fraud indicator, from the payment network server 110. The fourth transceiver 906 may transmit various requests and messages to the payment network server 110. For example, the fourth transceiver 906 may transmit the authorization response to the payment network server 110. Examples of the fourth transceiver 906 may include, but are not limited to, an antenna, a radio frequency transceiver, a wireless transceiver, a Bluetooth transceiver, an Ethernet port, a USB port, or any other device configured to transmit and receive data.

FIG. 10 is a block diagram that illustrates the transaction card 104, in accordance with an embodiment of the present invention. The transaction card 104 includes a fifth memory 1002.

The fifth memory 1002 includes suitable logic, circuitry, interfaces and/or codes, executable by the circuitry, for storing the IAC 208 and the threshold fraud limit 1004 (as described in FIGS. 2-5). The IAC 208 is stored in the fifth memory 1002 of the transaction card 104 by the issuer server 112. The threshold fraud limit 1004 is also set by the issuer server 112. Examples of the fifth memory 1002 may include a RAM, a ROM, a flash memory, or the like.

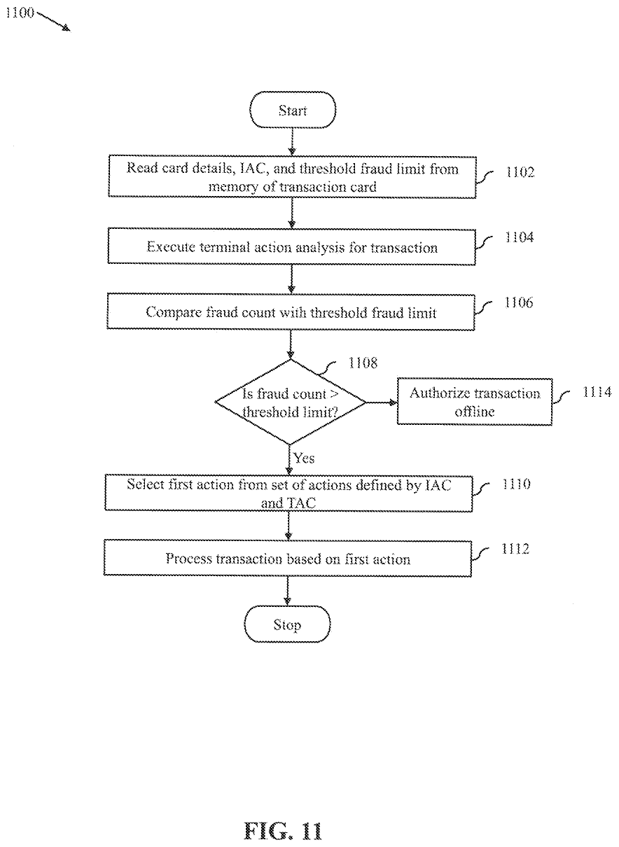

FIG. 11 represents a flow chart 1100 that illustrates a method for processing transactions at the terminal device 106, in accordance with an embodiment of the present invention. The user 102 initiates a transaction at the terminal device 106 by using the transaction card 104.

At step 1102, the terminal device 106 reads the card details of the transaction card 104, the IAC 208, the threshold fraud limit 1004, and one or more other parameters stored in the fifth memory 1002 of the transaction card 104. At step 1104, the terminal device 106 executes the terminal action analysis for the transaction (as described in FIGS. 3, 4, and 5). At step 1106, the terminal device 106 compares the fraud count 614 of the terminal device 106 with the threshold fraud limit 1004 read from the fifth memory 1002, during the terminal action analysis.

At step 1108, the terminal device 106 determines whether the fraud count 614 has exceeded the threshold fraud limit 1004. If at step 1108, it is determined that the fraud count 614 greater than the threshold fraud limit 1004, step 1110 is performed. At step 1110, the terminal device 106 selects the first action from the set of actions defined by the TAC 206 and the IAC 208. At step 1112, the terminal device 106 processes the transaction based on the first action that is selected. In one embodiment, when the first action selected by the terminal device 106 is to authorize the transaction online, the terminal device 106 communicates the transaction details of the transaction to the acquirer server 108. In another embodiment, when the first action selected by the terminal device 106 is to decline the transaction offline, the terminal device 106 declines the transaction. If at step 1108, it is determined that the fraud count 614 is less than or equal to the threshold fraud limit 1004, step 1114 is performed. At step 1114, the terminal device 106 authorizes the transaction offline.

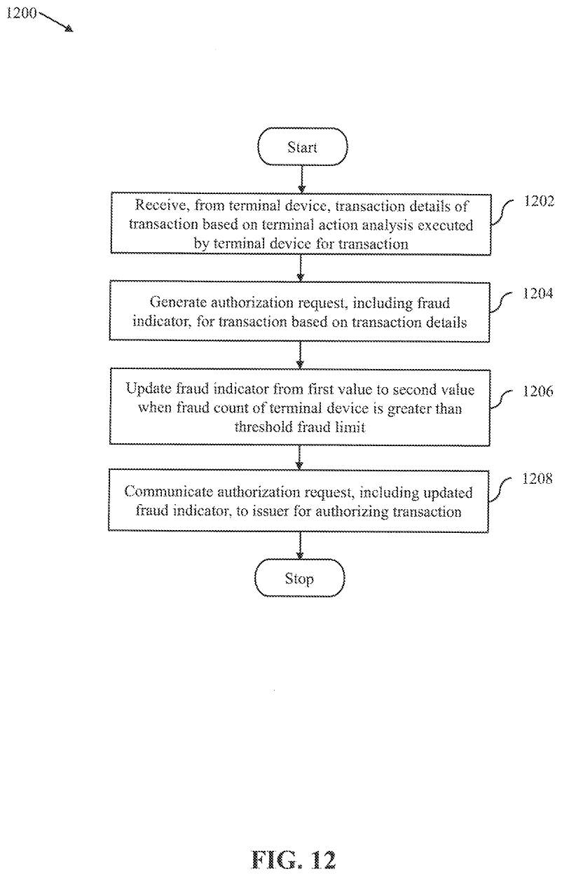

FIG. 12 represents a flow chart 1200 that illustrates a method for processing transactions at the acquirer server 108, in accordance with an embodiment of the present invention. At step 1202, the acquirer server 108 receives, from the terminal device 106, the transaction details of the transaction based on the terminal action analysis executed by the terminal device 106 for the transaction. The transaction details are indicative of the result of the terminal action analysis. The terminal device 106 may receive the transaction details when online action (i.e., to authorize the transaction online) is selected by the terminal device 106 during the terminal action analysis.

At step 1204, the acquirer server 108 generates an authorization request, including the fraud indicator, for the transaction based on the transaction details. At step 1206, the acquirer server 108 updates the fraud indicator from the first value (e.g., ‘0’) to the second value (e.g., ‘1’) when the fraud count 614 of the terminal device 106 is greater than the threshold fraud limit 1004. At step 1208, the acquirer server 108 communicates the authorization request, including the updated fraud indicator, to the issuer server 112 for authorizing the transaction.

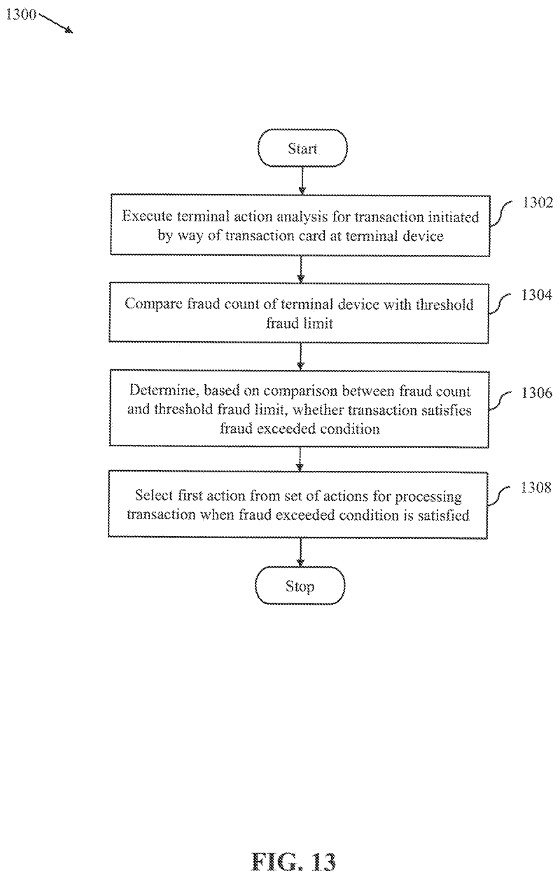

FIG. 13 represents a high-level flow chart 1300 that illustrates a method for processing transactions at the terminal device 106, in accordance with an embodiment of the present invention. The user 102 initiates a transaction at the terminal device 106 by using the transaction card 104. At step 1302, the terminal device 106 executes the terminal action analysis for the transaction initiated by way of the transaction card 104. At step 1304, the terminal device 106 compares the fraud count 614 of the terminal device 106 with the threshold fraud limit 1004. At step 1306, the terminal device 106 determines based on the comparison between the fraud count 614 and the threshold fraud limit 1004, whether the transaction satisfies the fraud exceeded condition. The fraud exceeded condition is satisfied when the fraud count 614 is greater than the threshold fraud limit 1004. At step 1308, the terminal device 106 selects the first action from the set of actions for processing the transaction when the fraud exceeded condition is satisfied. The set of actions is defined by the TAC 206 stored in the first memory 604 of the terminal device 106 and the IAC 208 stored in the fifth memory 1002 of the transaction card 104.

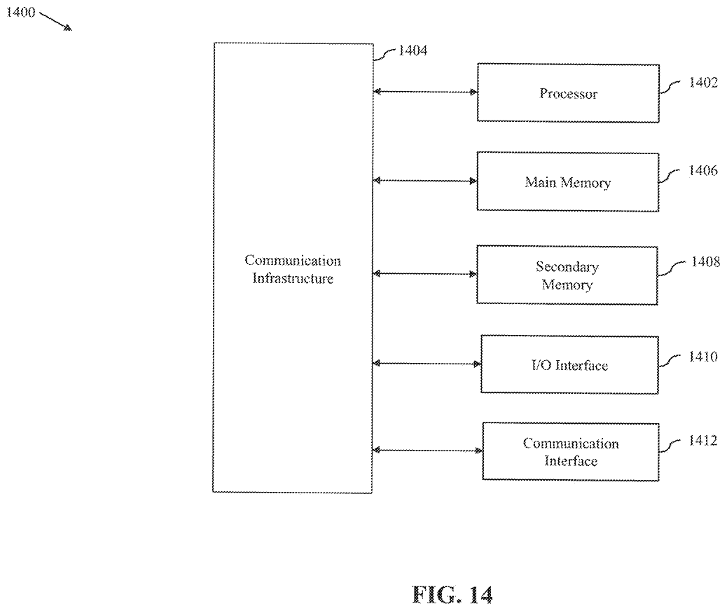

FIG. 14 is a block diagram that illustrates system architecture of a computer system 1400, in accordance with an embodiment of the present invention. An embodiment of present invention, or portions thereof, may be implemented as computer readable code on the computer system 1400. In one example, the acquirer server 108, the payment network server 110, and the issuer server 112, may be implemented in the computer system 1400 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 11, 12, and 13.

The computer system 1400 includes a processor 1402 that may be a special-purpose or a general-purpose processing device. The processor 1402 may be a single processor, multiple processors, or combinations thereof. The processor 1402 may have one or more processor cores. In one example, the processor 1402 is an octa-core processor. Further, the processor 1402 may be connected to a communication infrastructure 1404, such as a bus, message queue, multi-core message-passing scheme, or the like. The computer system 1400 may further include a main memory 1406 and a secondary memory 1408. Examples of the main memory 1406 may include RAM, ROM, or the like. The secondary memory 1408 may include a hard disk drive or a removable storage drive, such as a floppy disk drive, a magnetic tape drive, a compact disc, an optical disk drive, a flash memory, or the like. Further, the removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1400 further includes an input/output (I/O) interface 1410 and a communication interface 1412. The I/O interface 1410 includes various input and output devices that are configured to communicate with the processor 1402. Examples of the input devices may include a keyboard, a mouse, a joystick, a touchscreen, a microphone, or the like. Examples, of the output devices may include a display screen, a speaker, headphones, or the like. The communication interface 1412 may be configured to allow data to be transferred between the computer system 1400 and various devices that are communicatively coupled to the computer system 1400. Examples of the communication interface 1412 may include a modem, a network interface, i.e., an Ethernet card, a communications port, or the like. Data transferred via the communication interface 1412 may correspond to signals, such as electronic, electromagnetic, optical, or other signals as will be apparent to a person skilled in the art. The signals may travel via a communications channel (not shown) which may be configured to transmit the signals to devices that are communicatively coupled to the computer system 1400. Examples of the communications channel may include, but are not limited to, cable, fiber optics, a phone line, a cellular phone link, a radio frequency link, or the like.

The main memory 1406 and the secondary memory 1408 may refer to non-transitory computer readable mediums. These two non-transitory computer readable mediums may provide data that enables the computer system 1400 to implement the methods illustrated in FIGS. 11, 12, and 13. In an embodiment, the present invention is implemented using a computer implemented application, the computer implemented application may be stored in the main memory 1406 and/or the secondary memory 1408.

A person of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor such as the processor 1402 and a memory such as the main memory 1406 and the secondary memory 1408 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Technological improvements in the terminal device 106 enables the terminal device 106 to perform fraud limit exceeded check during the terminal action analysis for a transaction initiated at the terminal device 106. In addition to this, technological improvements in the acquirer server 108 enables the acquirer server 108 to generate an authorization request that includes the fraud indicator for the transaction. By way of the fraud indicator, the issuer server 112 is notified whether the fraud count (e.g., the fraud count 614) of the terminal device 106 is greater than the threshold fraud limit (e.g., the threshold fraud limit 1004) set by the issuer server 112. Thus, the issuer server 112 may take a preemptive decision by declining the transaction, thereby reducing the number fraudulent transactions. As the transaction is declined, no arbitration chargeback may be initiated for the transaction. Thus, the processing overhead of acquirers, issuers, and payment networks is reduced.

Techniques consistent with the present invention provide, among other features, systems and methods for processing transactions. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A method for processing transactions, the method comprising:
receiving, by a server from a terminal device, transaction details of a transaction based on a terminal action analysis executed by the terminal device for the transaction, wherein the transaction details are indicative of a result of the terminal action analysis executed by the terminal device;
generating, by the server, an authorization request, including a fraud indicator, for the transaction based on the transaction details;
updating, by the server, the fraud indicator from a first value to a second value when a fraud count of the terminal device is greater than a threshold fraud limit; and
communicating, by the server to an issuer, the authorization request, including the updated fraud indicator, for authorizing the transaction.

2. The method of claim 1, further comprising determining, by the server, the fraud count of the terminal device based on one or more arbitration chargebacks associated with the terminal device.

3. The method of claim 1, further comprising storing, by the server, the fraud count of the terminal device in a first memory of the terminal device, wherein the terminal device executes the terminal action analysis based on the fraud count.

4. The method of claim 3, further comprising storing, by the server, a set of terminal action codes in the first memory of the terminal device.

5. The method of claim 4, wherein a set of issuer action codes is stored by the issuer in a second memory of a transaction card used for initiating the transaction.

6. The method of claim 5, wherein the transaction details are received by the server from the terminal device based on a first action selected by the terminal device from a set of actions during the terminal action analysis, and wherein the set of actions is defined by the set of terminal action codes and the set of issuer action codes.

7. The method of claim 6, wherein the first action corresponds to online authorization of the transaction.

8. A system for processing transactions, the system comprising:
an acquirer server that is configured to:
receive, from the terminal device, transaction details of a transaction based on a terminal action analysis executed by the terminal device for the transaction, wherein the transaction details are indicative of a result of the terminal action analysis executed by the terminal device,
generate an authorization request, including a fraud indicator, for the transaction based on the transaction details,
update the fraud indicator from a first value to a second value when a fraud count of the terminal device is greater than a threshold fraud limit, and
communicate the authorization request, including the updated fraud indicator to an issuer for authorizing the transaction.

9. The system of claim 8, wherein the acquirer server is further configured to determine the fraud count of the terminal device based on one or more arbitration chargebacks associated with the terminal device.

10. The system of claim 8, wherein the acquirer server is further configured to store the fraud count of the terminal device in a first memory of the terminal device, and wherein the terminal device executes the terminal action analysis based on the fraud count.

11. The system of claim 10, wherein the acquirer server is further configured to store a set of terminal action codes in the first memory of the terminal device.

12. The system of claim 11, wherein a set of issuer action codes is stored by the issuer in a second memory of a transaction card used for initiating the transaction.

13. The system of claim 12, wherein the acquirer server receives the transaction details from the terminal device based on a first action selected by the terminal device from a set of actions during the terminal action analysis, and wherein the set of actions is defined by the set of terminal action codes and the set of issuer action codes.

14. The system of claim 13, wherein the first action corresponds to online authorization of the transaction.

15. A method for processing transactions, the method comprising:
executing, by a terminal device, a terminal action analysis for a transaction initiated by way of a transaction card at the terminal device, wherein the terminal action analysis includes:
comparing, by the terminal device, a fraud count of the terminal device with a threshold fraud limit;
determining, by the terminal device, based on the comparison between the fraud count and the threshold fraud limit, whether the transaction satisfies a fraud exceeded condition, wherein the fraud exceeded condition is satisfied when the fraud count is greater than the threshold fraud limit; and
selecting, by the terminal device, a first action from a set of actions for processing the transaction when the fraud exceeded condition is satisfied, wherein the set of actions is defined by a set of terminal action codes stored in a first memory of the terminal device and a set of issuer action codes stored in a second memory of the transaction card.

16. The method of claim 15, further comprising reading, by the terminal device, the set of issuer action codes from the second memory of the transaction card when the transaction card is used for initiating the transaction at the terminal device.

17. The method of claim 15, further comprising transmitting, by the terminal device to a server, transaction details of the transaction based on the first action that is selected by the terminal device.

18. The method of claim 17, wherein an authorization request, including a fraud indicator, is generated by the server based on the transaction details.

19. The method of claim 18, wherein the fraud indicator is updated by the server from a first value to a second value, and wherein the transaction is authorized based on the updated fraud indicator.

20. The method of claim 15, further comprising declining, by the terminal device, the transaction based on the first action that is selected by the terminal device.
